(19) United States
(12) Patent Application Publication
(10) Pub. No.: US 2015/0081439 A1
(43) Pub. Date: Mar. 19, 2015

(54) SYSTEM FOR EXPANDING CUSTOMER RELATIONSHIPS

(71) Applicant: BANK OF AMERICA CORPORATION, Charlotte, NC (US)

(72) Inventors: Erik Stephen Ross, Charlotte, NC (US); Katherine Ann Krumme, San Francisco, CA (US)

(21) Appl. No.: 14/553,331

(22) Filed: Nov. 25, 2014

Related U.S. Application Data
(63) Continuation of application No. 13/217,920, filed on Aug. 25, 2011.

(51) Int. Cl. G06Q 30/02

(52) U.S. Cl. CPC G06Q 30/0269; G06Q 30/0255
USPC 705/14.53

(57) ABSTRACT

Embodiments of the invention relate to systems, methods, and computer program products for offering products or services to existing customers of a merchant based on the likelihood that the customer will purchase additional products or services of the merchant, wherein a computing device monitors data that is indicative of a customer's personal circumstances and a processor analyzes changes in the data and correlates the changes to opportunities for the merchant to offer products or services to the customer. A computing device then receives an indication that the customer is proximate in time to a change in data that correlates to an opportunity for the merchant to offer products or services to the customer and communicates the offers for the correlated products or services to the customer.

### CROSS REFERENCE TO OTHER RELATED APPLICATIONS

This application claims priority from and is a continuation patent application of U.S. Non-Provisional patent application Ser. No. 13/217,920, filed on Aug. 25, 2011, and entitled “SYSTEM FOR EXPANDING CUSTOMER RELATIONSHIPS,” the contents of which are hereby incorporated by reference in their entirety.

### FIELD

In general, embodiments of the invention relate to methods, systems, apparatus and computer program products for merchants to identify changes in existing customers' personal circumstances that represent an opportunity to offer additional products or services to the customer and for communicating the offers to the customer.

### BACKGROUND

Oftentimes, merchants offer products and services to customers based on the customer's immediate expressed need. For example, a customer needs a car and a car dealer offers to sell the customer a car. The customer now has a car that needs to be insured and begins to look for an insurance provider. An insurance provider becomes aware of the customer's need when the customer calls and offers the customer automobile insurance. However, if the merchant is unaware of the customer's specific need and the customer does not express the need directly to the merchant, the merchant may miss an opportunity to provide the customer with products or services that the merchant is prepared to provide. Further, the customer may miss an opportunity to be offered products and services that the customer is not yet aware that she needs, but that the merchant anticipates the customer will need based on the merchant's understanding of customers it has encountered under similar circumstances.

It may be possible to predict the products or services a customer will be willing to purchase based on the customer's personal circumstances. A merchant can use its experience in offering products or services to customers with similar personal circumstances to predict the products or services that other customers may be interested in purchasing. Accordingly, a system that could analyze a customer's personal circumstances and identify changes to the customer's personal circumstances would allow a merchant to predict the products or services that may be desirable to the customer and allow a merchant to offer the products or services to the customer as the customer is recognizing his or her own need. This can help a merchant to expand its relationship with existing customers by timely offering new products or services to customers at the time the customer is most likely to be interested in purchasing the new products or services.

Additionally, there are times that a specific merchant has access to information about a customer, based on the merchant's prior dealings with the customer, regarding a customer's personal circumstances or changes to the customer's personal circumstances that are not readily available to other merchants that have a business relationship with the first merchant. For instance, a financial institution may have access to certain customer data that indicates an imminent change in a customer's personal circumstances that is not apparent to one of the financial institution's retail partners. Because the retail partner is not aware of the customer's personal circumstances it is not able to tailor its offer of products or services to suit the customer's present or imminent need and the customer may receive offers that are not relevant to her circumstances and miss the opportunity to purchase products or services that are more relevant.

Recent years have seen a vast expansion of the use of social networks to connect individuals, access information and communicate with groups of people that share similar backgrounds, interests or characteristics. The rise of social networks presents an opportunity for merchants to both identify information about their customers and to communicate offers for products and services to customers based on available information regarding the customer's needs.

Therefore, a need exists for a system that can monitor and analyze a customer's personal circumstances, including data from a customer's social network, and identify changes in the customer's circumstances that represent an opportunity for a merchant to offer products or services to the customer that are specifically tailored to the customer's upcoming need and communicate the offers to the customer.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Some embodiments of the present invention provide a method for offering products or services to existing customers of a merchant based on the likelihood that the customer will purchase additional products or services, wherein a computing device monitors data that is indicative of a customer's personal circumstances and a processor analyzes changes in the data and correlates the changes to opportunities to offer products or services to the customer. A computing device then receives an indication that the customer is proximate in time to a change in data that correlates to an opportunity to offer products or services to the customer and communicates the offers for the correlated products or services to the customer.

In some embodiments of the invention, the data indicating a change in the customer's personal circumstances is transactional data that is available to the merchant. In other embodiments, the data indicating a change in the customer's personal circumstances is account history data available to the merchant. In yet other embodiments, the data is biographical data available to the merchant. In certain embodiments monitoring data that is indicative of a customer's personal circumstances involves monitoring, via a processor, the customer's social network.

In certain embodiments, communicating offers to the customer comprises extending an offer to a contact in the customer's social network with a positive relationship with the merchant, wherein the offer can be shared with other customers. In some such embodiments, extending an offer to a connection in the customer's social network that has a positive relationship with the merchant further comprises determining the levels of connection between two or more of the connections of the customer, comparing the levels of connection, developing a hierarchy of connection based on the levels of connection, identifying those connections with a positive relationship with the merchant, and choosing one or more of the two or more connections based on the hierarchy of connection and the connection's positive relationship with the merchant.

Embodiments of the invention also provide an apparatus for identifying and offering products or services to an existing customer of a merchant based on the likelihood that the customer will purchase additional products or services of the merchant, the apparatus comprising a computing platform that features a memory and at least one processor. A customer data monitoring application is stored in the memory, executable by the processor and configured to monitor data that is indicative of a customer's personal circumstances. A data analysis routine is also stored in the memory, executable by the processor and configured to analyze the data, along with a change analysis routine that is stored in the memory, executable by the processor and configured to correlate changes in the data to opportunities to offer products or services to the customer. An alert application is stored in the memory as well, executable by the processor and configured to receive an indication that the customer is proximate in time to a change in data that correlates to an opportunity to offer products or services to the customer. The alert application includes an alert determination routine configured to determine that products or services should be offered to the customer and an alert communication routine that is configured to generate and initiate communication of the offer of products or services to the customer.

In some embodiments, the customer data monitored by the customer data monitoring application is the customer's transactional data available to the merchant. In some embodiments the customer data monitoring application is configured to monitor the customer's account history data. In other embodiments the customer data monitoring application monitors the customer's biographical data that is available to the merchant. In specific embodiments of the apparatus, the customer data monitoring application is further configured to monitor the customer's social network data.

In some embodiments, the alert application is configured to extend offers to a contact in the customer's social network with a positive relationship with the merchant, wherein the offer can be shared with other customers.

Embodiments of the present invention also provide a computer program product comprising a computer-readable medium having computer-executable code stored thereon. In one embodiment, the computer-executable code includes: a first set of code for causing a computer to monitor data that is indicative of a customer's personal circumstances; a second set of code for causing a computer to analyze said data; a third set of code for causing a computer to correlate changes in the data to opportunities to offer products or services to the customer; a fourth set of code for causing an indication that the customer is proximate in time to a change in data that correlates to an opportunity to offer products or services to said customer; and a fifth set of code for causing a computer to communicate offers for the correlated products to the customer.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a process flow for an apparatus for offering products or services to an existing customer of a merchant based on the likelihood the customer will purchase additional products or services, in accordance with embodiments of the invention.

FIG. 2 is a flow diagram illustrating a process flow for an apparatus for monitoring data that is indicative of a customer's personal circumstances, in accordance with embodiments of the invention.

FIG. 3 is a flow diagram illustrating a process flow for an apparatus for communicating offers for the correlated products or services to the customer, in accordance with embodiments of the invention.

FIG. 4 is a. flow diagram illustrating a process flow for an apparatus for extending an offer to a connection in the customer's social network that has a positive relationship with the merchant, in accordance with embodiments of the invention.

FIG. 5 is a block diagram illustrating an apparatus, in accordance with embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Although embodiments of the present invention described herein are generally described as involving a merchant, it will be understood that merchant may involve one or more persons, organizations, businesses, institutions and/or other entities such as financial institutions, services providers etc. that implement one or more portions of one or more of the embodiments described and/or contemplated herein.

It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks such as Facebook®, Twitter®, Linkedin®, YouTube® as well as any one or more existing web logs or “blogs,” forums and other social spaces.

It will be further understood that “connection” or “connections” as used herein in the context of a social network refers to one or more members of an individuals' social network. For example, a person's family members or friends may be considered individually as a connection within the person's social network, or collectively as the person's connections.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, apparatus, systems, methods and computer program products are herein disclosed for merchants to identify changes in existing customer's personal circumstances that represent an opportunity to offer additional products or services to the customer and for communicating the offers to the customer. Embodiments of the present invention will leverage the information available to a merchant to identify data that is indicative of a change to an existing customer's personal circumstances. Such changes of circumstance may include, but are not limited to, graduation from college, a new job, marriage, the birth of a child, the purchase of a house, the purchase of a car, a member of the household starting college etc. By identifying a customer's change of personal circumstance, the merchant can either directly grow its relationship with the customer by offering additional products and services that are relevant to the customer's need or provide the information to the merchant's business partners who in turn can offer additional products or services. In specific embodiments, the data that is used to identify a change in the customer's personal circumstances is specific to financial institutions, such as financial transaction data, financial account history data and biographical data. In this regard, some of the embodiments disclosed herein relate to a financial institution utilizing the data available to it to offer additional financial products or services to its customers.

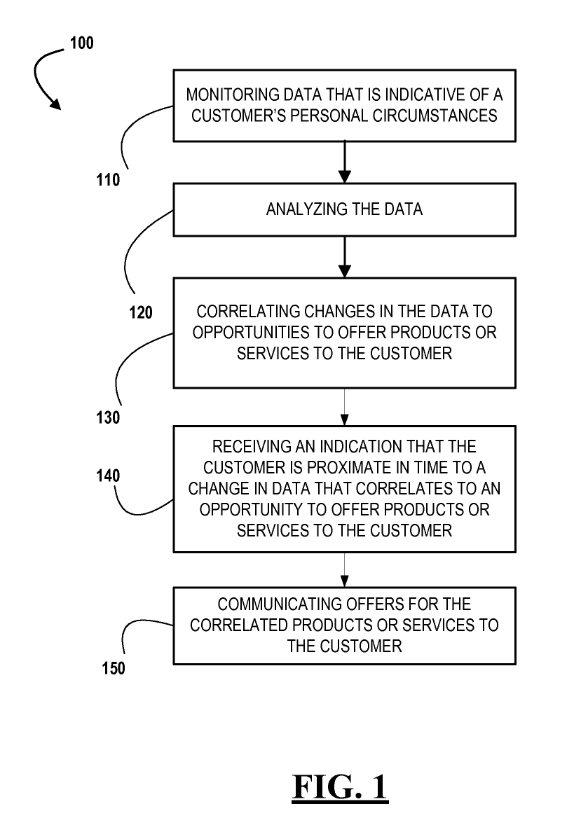

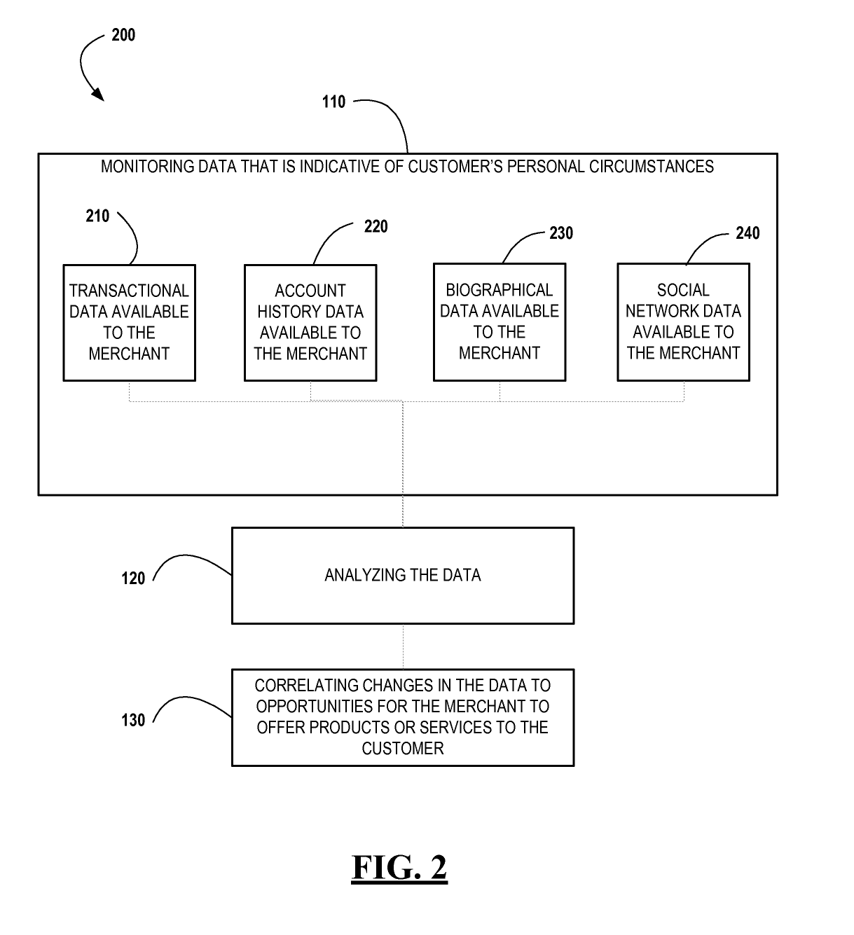

FIG. 1 illustrates a general process flow 100 for offering products or services to an existing customer of a merchant based on the likelihood that the customer will purchase additional products or services, in accordance with an embodiment of the present invention. As represented by block 110 a merchant, for example using a computing device, monitors data that is indicative of a customer's personal circumstances. The merchant then analyzes the data as represented by block 120 and correlates changes in the data to opportunities for the merchant to offer products or services to the customer 130. As represented by block 140 the merchant receives an indication that the customer is proximate in time to a change in data that correlates to an opportunity to offer products or services to the customer. It will be understood that the monitoring, analyzing and correlating of data is done dynamically so that the merchant receives timely indications that the customer is proximate in time to a change in circumstance that may represent an opportunity to expand the relationship with the customer. At block 150, the merchant, or a business partner, communicates offers for the correlated products or services to the customer. Embodiments of the process 100, and systems for performing the process 100, are described in greater detail below with reference to FIGS. 2-5.

FIG. 2 provides a flow diagram 200 illustrating a general process flow of an apparatus or system for monitoring data that is indicative of a customer's personal circumstances 110. Such data may include the customer's transactional data available to the merchant, as represented by block 210. Transactional data includes, but is not limited to, data regarding the date, location, amount, method of payment etc. of the transactions of the customer. Transactional data can be information relating to a present transaction (i.e. the purchase of a car) or can be historical data relating to previous purchases. The data monitored by the merchant may also include the customer's account history data, as illustrated by block 220. Account history data includes, without limitation, such data as the types of accounts the customer has with the merchant (e.g. credit, checking, savings, investment, lay-away, financing etc.) and the current and historical balances of such accounts, account activity etc. As exemplified by block 230, the data monitored by the merchant may also include biographical data of the customer. Biographical data includes, but is not limited to, the age, sex, marital status, place of residence, current location, number of children, employment status etc. of a customer. The merchant may also monitor a customer's personal circumstances by monitoring the customer's social network data, as represented by block 240. A number of connections within the customer's social network will be identifiable to the merchant through the other types of information available to the merchant. For instance, the transactional data available to the merchant may illustrate the businesses connections within the customer's social network based on frequent transactions with the business. Similarly the transactional data and/or the account history data may demonstrate recurring deposits from a company representing an employer connection. Biographical data available to the merchant may identify the customer's family connections. Determining a customer's social network may also involve the merchant associating itself with the customer on an already-existing social network, such as Facebook®, wherein the merchant may receive access to additional information regarding the customer's connections. Additionally, a customer may provide the merchant access to the customer's e-mail or other electronic communications, or some portion thereof (e.g. recipient's name, contents of the “re” line etc.) to identify those individuals or organizations with which the customer regularly corresponds or interacts. Furthermore, the merchant may independently create a unique social network and invite the customer to join the network and to bring his or her connections. As illustrated by the remainder of the process flow 200, the merchant analyzes the data it monitors, 120 and correlates changes in the data to opportunities for the merchant to offer products or services to the customer 130.

Information from the transactional data 210, account history data 220, biographical data 230 and social network data 240 may be considered separately or combined to identify a change in the customer's personal circumstances. For instance, and without limitation, a car dealership may know from prior dealings with a customer that the customer has three children, including a middle daughter who turned sixteen last week. The car dealer also knows from its transactional data and account history data that the customer purchased a car for his older child shortly after the child turned sixteen and financed the car through one of the car dealership's partners. The car dealership may also be connected to this customer through Facebook® and learn from a status update posted to the customer's Facebook® account that the customer's middle daughter recently passed her driver's exam and was issued a driver's license. The car dealer may also be able to determine based on its relationship with the customer through Facebook® (such as comments made by connections, postings etc.) that a number of the customer's friends purchased cars for their children when the children turned sixteen. Based on an analysis of this information, the car dealer may conclude that the customer is proximate in time to the purchase of a new car for his daughter and be in a position to target offers to the customer that are relevant to this need. Moreover, the car dealership may be able to share this information with other service providers with which it partners, such as a financial institution, insurance company or aftermarket accessory sellers, to indicate the customer may soon be purchasing a new car and may be receptive to relevant offers.

Monitoring the different data points (e.g. transactional, account history, biographical and social network data) will demonstrate patterns of behavior that may allow a merchant to identify potential changes. For instance, if a customer is from the southeast and rarely travels but has made repeated trips to the Pacific Northwest, first traveling by himself, then with his spouse and finally with his children it may suggest that the family is anticipating a move and the merchant may have an opportunity to communicate offers (e.g. identifying a local branch in the Pacific Northwest) that may allow the merchant to extend its relationship with the customer.

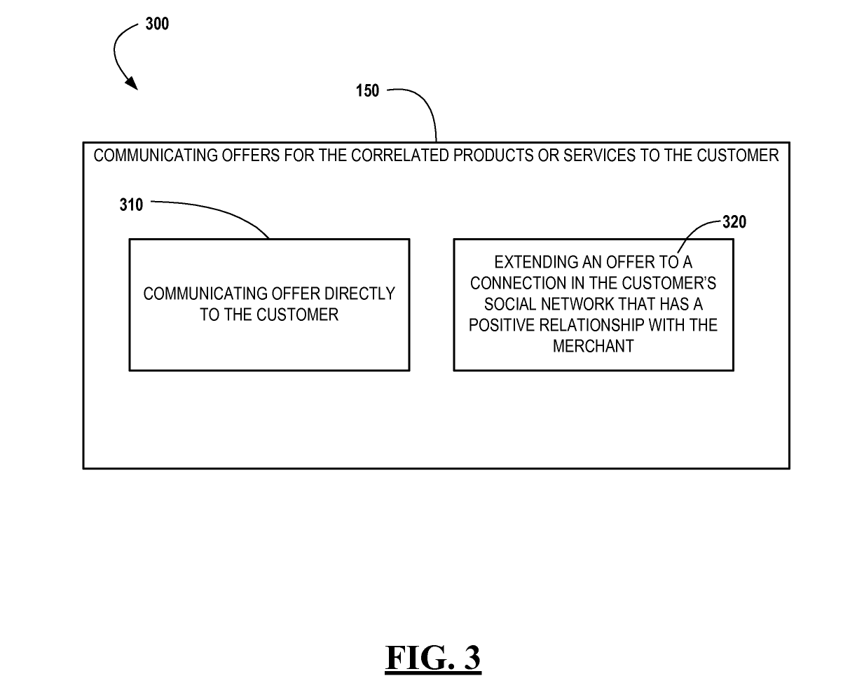

Referring now to FIGS. 1 and 3, after the data is correlated to opportunities to offer products or services to the customer 130 and an indication is received that the customer is proximate in time to a change in data that correlates to an opportunity to offer products or services to the customer 140, the offers are communicated to the customer 150. FIG. 3 illustrates a general process flow 300 for communicating offers for the correlated products or services to the customer. As represented by block 310, the offers can be communicated directly to the customer. Such a communication can take any form sufficient to accomplish this purpose, including an automatically generated coupon electronically sent to the customer via e-mail or otherwise over the Internet, a direct mail offer, customer service contact, a gift card, deductions from outstanding balances, a notification of upcoming sales etc. Communicating the offer directly to the customer may also comprise the merchant sharing the indication of block 140 with a partner business that provides the correlated products or services, who in turn communicates the offer directly to the customer 310. By way of example, a financial institution may determine from biographical data 230 available to it that a customer has a niece that is about to start her senior year of high school. The financial institution may also be able to determine from available social network data 240 that the niece is planning on attending college and that the customer and niece are close and have been discussing the issue. Based on this information, the financial institution may send an e-mail to the customer or include a banner advertisement on its website when the customer logs on to the financial institution's online banking environment advertising its 529 college savings plans with a brief description of the eligible beneficiaries. In view of the customer's relationship with his niece and inasmuch as the offer is delivered proximate in time to when the niece may be able to use the proceeds from a 529 account, this offer can result in the financial institution's expanding its relationship with the customer. As represented by block 320, the offer may also be communicated to the customer, by extending an offer to a connection in the customer's social network that has a positive relationship with the merchant. The connections in a customer's social network may be more effective at inducing the customer to purchase additional products or services inasmuch as the customer's friends, family, co-workers etc. may have greater influence over whether the customer considers certain products or services desirable. Furthermore, connections in a social network may also be at similar life stages, having similar interests or experiences that may indicate the connections would also be receptive to the products or services being offered to the customer.

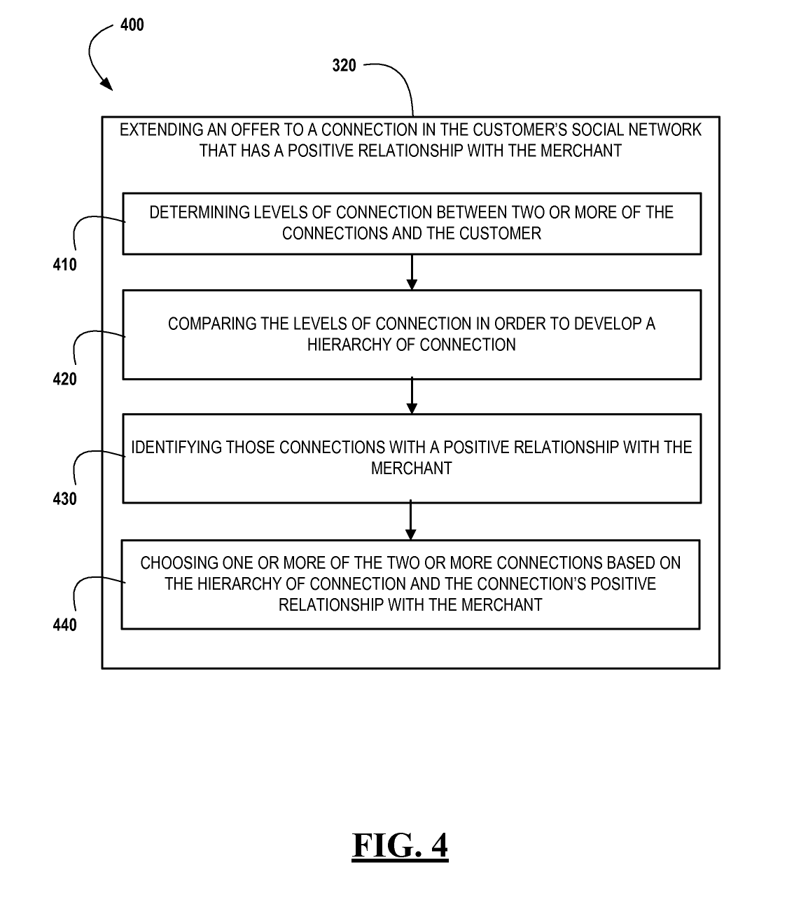

Referring now to FIG. 4, a general process flow 400 is provided for extending an offer to a connection in the customer's social network that has a positive relationship with the merchant. As represented by block 410, a determination must be made of the levels of connection between two or more of the connections in the customer's social network and the customer and those levels of connection must be compared in order to develop a hierarchy of connection, shown in process flow 400 at block 420. As defined herein, a customer's social network may include a wide variety of individuals and/or organizations ranging from the customer's closest friend to an individual with which the customer has little to no personal interaction, such as a person who works in a different department of the same company as the individual. The customer may put significant weight on his or her best friend's opinion of a specific company, product or service, while giving little to no consideration of the opinion of a little known work colleague. Moreover, a connection in the customer's social network that has a positive opinion of the merchant will be more effective in communicating the merchant's offer for specific products or services. Accordingly, a balance must be made between the closeness of a connection to the customer and the connection's relationship with the merchant. Certain embodiments of the present invention incorporate this consideration as illustrated at block 430, wherein those connections with a positive relationship with the merchant are identified and in block 440, wherein the merchant chooses one or more of the two or more connections based on the hierarchy of connection and the connection's positive relationship with the merchant.

The levels of connection between two or more of the connections and the customer can be determined in any manner suitable for the purpose. For instance, and without limitation, the levels of connection may be determined through self-identification, i.e. both parties indicate they are siblings, a photograph from a family reunion is uploaded to a social network and the caption identifies both parties as members of the family, the customer identifies a connection as his or her best friend, the customer indicates that the connection is someone whose opinion they respect etc. The levels of connection may also be determined through the frequency of traffic between the customer and connection over the social network. For example, if the customer sends direct communications to a connection more frequently than she does other connections within the social network it may be because the customer has a higher level of connection with the individual. Similarly if the customer interacts directly with the posts or information uploaded by the connection to a social network more often than he does with other connections it may be indicative of a higher degree of connection. Moreover, the levels of connection may be determined from an analysis of similarities between the customer and the connections. For instance, and without limitation, data available to the merchant, including social network data can be analyzed to determine if the customer and a connection have similar patterns of behavior, such as shopping patterns (e.g. they frequent the same stores with similar regularity etc.). If the customer and one or more connection share a high degree of similarities in their behavior, the level of connection may be higher, that is the connection may be better able to influence the customer than is otherwise indicated by the amount of direct interaction between the customer and the connection.

Identifying those connections with a positive relationship with the merchant can also be accomplished in a number of different ways, including but not limited to, analyzing the transactional, account history and biographical data available to the merchant to determine if any of the identified connections have previously conducted business with the merchant and whether there are factors indicating that connection has a positive opinion of the merchant (i.e. recurring purchases, long term relationship, refers other customers etc.). Moreover, the merchant may have records from its customer service department such as call center transcripts indicating either positive or negative interactions with the connection. Whether a connection has a positive relationship with the merchant may also be determined from social network data. For instance, the connection may follow the merchant's Twitter® feed, have “Liked” the merchant's Facebook® page or be an active contributor on the social networking site developed by the merchant. The connection's opinion of the merchant may also be evident from comments, blog entries, videos, websites etc. that the connection has made available on the Internet.

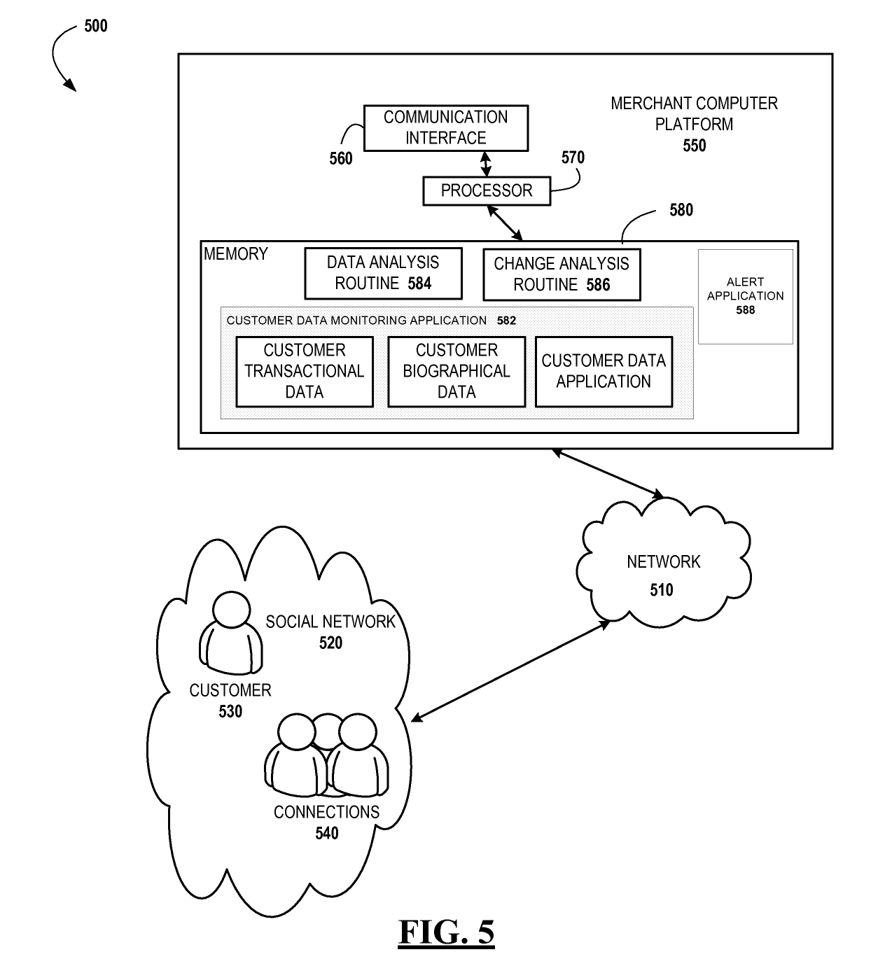

It will be understood that the method for offering products or services to an existing customer of a merchant based on the likelihood that the customer will purchase additional products or services, as illustrated by the process flows 100, 200, 300 and 400 of FIGS. 1-4 can be embodied in a number of different apparatuses and systems. FIG. 5 provides a block diagram illustrating the technical components of such a system 500, in accordance with an embodiment of the present invention. As illustrated, the system 500 includes a network 510, a social network 520 and a merchant computer platform 550.

The merchant computer platform 550 may include any computerized apparatus that can be configured to perform any one or more of the functions of the invention described herein. In accordance with some embodiments, for example, the merchant computer platform 550 may include an engine, a platform, a server, a database system, a front end system, a back end system, a personal computer system, and/or the like. In some embodiments, such as the one illustrated in FIG. 5, the merchant computer platform 550 includes a communication interface 560 a processor 570 and a memory 580. The communication interface 560 is operatively and selectively connected to the processor 570, which is operatively and selectively connected to the memory 580.

The communication interface 560 generally includes hardware, and, in some instances, software, that enables the merchant computer platform 550 to transport, send, receive, and/or otherwise communicate information to or from other communication interfaces. For example, the communication interface 560 may include a modem, server, electrical connection and/or other electronic devices that operatively connect the merchant computer platform 550 to another electronic device.

The processor 570 generally includes circuitry or executable code for implementing the audio, visual, and/or logic functions of the merchant computer platform 550. For example, the processor may include a digital signal processor device, a microprocessor device, and various analog-to-digital converters, digital-to-analog converters, and other support devices. Control and signal processing functions of the system in which the processor resides may be allocated between these devices according to their respective capabilities. The processor 570 may also include functionality to operate one or more software programs based at least partially on computer-executable program code portions thereof, which may be stored, for example, in a memory device, such as the memory 580 of the merchant computer platform 550.

The memory 580 may include any computer-readable medium. For example, memory may include volatile memory, such as volatile random access memory (RAM) having a cache area for the temporary storage of data. Memory 580 may also include non-volatile memory, which may be embedded and/or may be removable. The non-volatile memory may additionally or alternatively include an EEPROM, flash memory, and/or the like. The memory 580 may store any one or more pieces of information and data used by the merchant computer platform 550 to implement the functions of the merchant computer platform 550.

It will be understood that the merchant computer platform 550 can be configured to implement one or more portions of the process flows described and/or contemplated herein. For example, as illustrated in FIG. 5, a customer data monitoring application 582 may be stored in the memory 580, executable by the processor 570 and configured to monitor data that is indicative of a customer's personal circumstances. A data analysis routine 584 configured to analyze the data and a change analysis routine 586 configured to correlate changes in the data to opportunities for the merchant to offer products or services to the customer may also both be stored in the memory 580 and executable by the processor 570. In some embodiments, an alert application 588 is stored in the memory 580, executable by the processor 570 and configured to receive an indication that the customer is proximate in time to a change in data that correlates to an opportunity for the merchant to offer products or services to the customer, wherein the alert application 588 includes an alert determination routine configured to determined that the merchant should offer products or services to the customer and an alert communication routine configured to generate and initiate communication of the offer of products or services to the customer.

As shown in FIG. 5, the social network 520 and merchant computer platform 550 are each operatively and selectively connected to the network 510, which may include one or more separate networks. In addition, the network 510 may include a local area network (LAN), a wide area network (WAN), and/or a global area network (GAN), such as the Internet. It will also be understood that the network 510 may be secure and/or unsecure and may also include wireless and/or wireline technology.

It will be understood that the merchant computer platform in performing one or more portions of the process flows described and/or contemplated herein will operatively connect to the network 510 through the communication interface 560 to receive data from and/or communicate data to the customer 530 or connections 540 within the social network 520. For instance, in monitoring the customer's social network as part of monitoring data that is indicative of the customer's personal circumstances (as illustrated in FIG. 2, blocks 110 and 240), the merchant computer platform 550 may access the social network 520 over the network 510 to identify the connections 540 in the customer's 530 social network 520 and monitor information indicating a change in the customer's personal circumstances (e.g. comments, photos or posts concerning the customer's pregnancy and imminent delivery of the customer's first baby etc.). Similarly, in communicating offers for correlated products or services to the customer by extending an offer to a connection in the customer's social network that has a positive relationship with the merchant (as illustrated in FIG. 3, blocks 150 and 320), the merchant computer platform 550 may access the social network 520 and use the alert communication routine of the alert application 588 to utilize the communication interface 560 to transmit an offer to one or more connections 540 within the customer's 530 social network 520.

By way of example, and without expressing any limitation on the function of the methods, systems and apparatuses described and/or contemplated herein, in use, a merchant, such as a financial institution, may monitor the personal circumstances of an existing customer through the transactional data 210, account history data 220, and biographical data 230 available to the financial institution using the customer data monitoring application 582 of the merchant computer platform 550. From its analysis of this data 120, the financial institution may become aware that a customer has a child that is about to start college (i.e. the biographical data indicates the customer has a child that is eighteen and the transactional and account data indicate that an application fee was paid to a university followed a number of months later by a deposit made to the same university) and receive an indication that this change of personal circumstance may represent an opportunity to offer the customer new services 140, such as pre-paid credit cards, a no-fee joint checking account etc. that the customer currently does not use. The financial institution may then communicate the offer for the additional services to the customer 150 at a time when the customer is most likely to be receptive such an offer. Moreover, the financial institution may communicate this information to merchants with whom the financial institution has a relationship, such as a bike shop, clothing store, apartment complex etc. in the town where the university the customer's child will be attending is located.

As another, non-limiting example of an embodiment of the invention in use, the financial institution may monitor a customer's transaction and account data 110, analyze the data 120 and note that the customer has substantial new recurring direct deposits that occur on a bi-weekly basis and conclude that the customer has graduated from college and started a new job. The financial institution may correlate this change in circumstance as an opportunity to offer the customer services relating to investing 130. Moreover, the customer's transactional data may indicate that the customer drinks coffee and the financial institution may recognize that with the customer's change of personal circumstance, i.e. the new job, the customer may have additional disposable income to spend on coffee. Accordingly, the financial institution may inform one of its business partners, which sells premium coffee and coffee makers that the customer may be receptive to an offer for these products 140. The partner business may then identify a connection within the customer's social network that has positive relationship with the business and provide the connection with an offer for a six month supply of coffee with a purchase of a coffee maker, wherein the offer can be shared with others 320.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A computer implemented method for offering products or services to an existing customer of a merchant based on the likelihood that the customer will purchase additional products or services, the method comprising:
monitoring, by a computing device processor, customer data that is indicative of a customer's personal circumstances, wherein said customer data comprises transactional data, account history data, biographical data, social network data, and email data;
analyzing, by a computing device processor, changes in said customer data;
correlating, by a computing device processor, changes in said data to opportunities to offer products or services to said customer;
receiving, by a computing device processor, an indication that the customer is proximate in time to a change in customer data that correlates to an opportunity to offer products or services to said customer;
sharing, by a computing device processor, the indication with one or more partnering service providers; and
communicating, by a computing device processor, offers for the correlated products or services to the customer.

2. The method of claim 1, wherein communicating offers to the customer comprises extending an offer to a contact in the customer's social network that has a positive relationship with the merchant, wherein the offer can be shared with other customers, and wherein the positive relationship between the contact in the customer's social network and the merchant is determined by:
determining the levels of connection between two or more of the connections of the customer;
comparing the levels of connection;
developing a hierarchy of connection based on the levels of connection;
identifying those connections with a positive opinion of the merchant recorded in a call center transcript; and
choosing one or more of the two or more connections based on the hierarchy of connection and the connections positive relationship with the merchant.

3. The method of claim 2, wherein determining the levels of connection between two or more of the connections of the customer comprises:
determining a number of interactions between the customer and at least one of the two or more connections of the customer have occurred;
comparing the determined number of interactions with a predetermined threshold value; and
determining the determined number of interactions is greater than the predetermined threshold value, thereby confirming that at least one or the two or more connections of the customer is a contact in the customer's social network.

4. The method of claim 2, wherein determining the levels of connection between two or more of the connections of the customer comprises:
analyzing an image of the customer and at least one of the two or more connections of the customer;
analyzing an image caption of the image of the customer and at least one of the two or more connections of the customer; and
confirming that at least one of the two or more connections of the customer is a contact in the customer's social network based on the analysis of the image and the image caption.

5. The method of claim 1, wherein monitoring customer data that is indicative of a customer's personal circumstances comprises:
receiving customer data of the customer; and
identifying customer data of the customer that is indicative of the customer's personal circumstances.

6. The method of claim 1, wherein sharing the indication with the one or more partnering service providers comprises sharing the customer data that is indicative of a customer's personal circumstances with the one or more partnering service providers.

7. The method of claim 1, wherein the offers for the correlated products or services are communicated to the customer from the one or more partnering service providers.

8. An apparatus for offering products or services to an existing customer of a merchant based on the likelihood that the customer will purchase additional products or services, the apparatus comprising:
a computing platform including at least one non-transitory electronic storage device and at least one processor;
a customer data monitoring application stored in the at least one non-transitory electronic storage device, the customer data monitoring application comprising instruction code that is executable by the processor and configured to cause said processor to monitor customer data that is indicative of a customer's personal circumstances, wherein said customer data comprises transactional data, account history data, biographical data, social network data, and email data;
a data analysis routine stored in the at least one non-transitory electronic storage device, the data analysis routine comprising instruction code that is executable by the processor and configured to cause said processor to analyze changes in said customer data;
a change analysis routine stored in the in the at least one non-transitory electronic storage device, the change analysis routine comprising instruction code that is executable by the processor and configured to cause said processor to correlate changes in said customer data to opportunities to offer products or services to said customer;
an alert application stored in the at least one non-transitory electronic storage device, the alert application comprising instruction code that is executable by the processor and configured to cause said processor to receive an indication that the customer is proximate in time to a change in customer data that correlates to an opportunity to offer products or services to the customer and including:
an alert determination routine stored in the at least one non-transitory electronic storage device, the alert determination routine comprising instruction code that is executable by the processor and configured to cause said processor to determine that products or services should be offered to the customer; and
an alert communication routine stored in the at least one non-transitory electronic storage device, the alert communication routine comprising instruction code that is executable by the processor and configured to cause said processor to:
share the indication with one or more partnering service providers; and
generate and initiate communication of the offer of products or services to the customer.

9. The apparatus of claim 8, wherein the alert application further comprises instruction code that is executable by the processor and configured to cause said processor to extend an offer to a contact in the customer's social network that has a positive relationship with the merchant, wherein the offer can be shared with other customers, and wherein the positive relationship between the contact in the customer's social network and the merchant is determined by:
determining the levels of connection between two or more of the connections of the customer;
comparing the levels of connection;
developing a hierarchy of connection based on the levels of connection;
identifying those connections with a positive opinion of the merchant recorded in a call center transcript; and
choosing one or more of the two or more connections based on the hierarchy of connection and the connections positive relationship with the merchant.

10. The apparatus of claim 9, wherein the instruction code that is executable by the processor and configured to cause said processor to determine the levels of connection between two or more of the connections of the customer comprises instruction code that is executable by the processor and configured to cause said processor to:
determine a number of interactions between the customer and at least one of the two or more connections of the customer have occurred;
compare the determined number of interactions with a predetermined threshold value; and
determine the determined number of interactions is greater than the predetermined threshold value, thereby confirming that at least one or the two or more connections of the customer is a contact in the customer's social network.

11. The apparatus of claim 9, wherein the instruction code that is executable by the processor and configured to cause said processor to determine the levels of connection between two or more of the connections of the customer comprises instruction code that is executable by the processor and configured to cause said processor to:
analyze an image of the customer and at least one of the two or more connections of the customer;
analyze an image caption of the image of the customer and at least one of the two or more connections of the customer; and
confirm that at least one of the two or more connections of the customer is a contact in the customer's social network based on the analysis of the image and the image caption.

12. The method of claim 1, wherein the instruction code that is executable by the processor and configured to cause said processor to monitor customer data that is indicative of a customer's personal circumstances comprises instruction code that is executable by the processor and configured to cause said processor to:
receive customer data of the customer; and
identify customer data of the customer that is indicative of the customer's personal circumstances.

13. The method of claim 1, wherein the instruction code that is executable by the processor and configured to cause said processor to share the indication with the one or more partnering service providers comprises instruction code that is executable by the processor and configured to cause said processor to share the customer data that is indicative of a customer's personal circumstances.

14. The method of claim 1, wherein the offers for the correlated products or services are communicated to the customer from the one or more partnering service providers with the one or more partnering service providers.

15. A computer program product comprising a non-transitory computer-readable medium comprising instruction code configured to cause an apparatus to:
monitor customer data that is indicative of a customer's personal circumstances, wherein said customer data comprises transactional data, account history data, biographical data, social network data, and email data;
analyze changes in said customer data;
correlate changes in said customer data to opportunities to offer products or services to said customer;
receive an indication that the customer is proximate in time to a change in customer data that correlates to an opportunity to offer products or services to said customer;
share the indication with one or more partnering service providers; and
communicate offers for the correlated products or services to the customer.

16. The computer program product of claim 15, wherein the non-transitory computer-readable medium further comprises instruction code configured to cause an apparatus to extend an offer to a contact in the customer's social network that has a positive relationship with the merchant, wherein the offer can be shared with other customers, and wherein the positive relationship between the contact in the customer's social network and the merchant is determined by:
determining the levels of connection between two or more of the connections of the customer;
comparing the levels of connection;
developing a hierarchy of connection based on the levels of connection;
identifying those connections with a positive opinion of the merchant recorded in a call center transcript; and
choosing one or more of the two or more connections based on the hierarchy of connection and the connections positive relationship with the merchant.

17. The apparatus of claim 16, wherein the instruction code configured to cause an apparatus to determine the levels of connection between two or more of the connections of the customer further comprises instruction code configured to cause an apparatus to:
determine a number of interactions between the customer and at least one of the two or more connections of the customer have occurred;
compare the determined number of interactions with a predetermined threshold value; and
determine the determined number of interactions is greater than the predetermined threshold value, thereby confirming that at least one or the two or more connections of the customer is a contact in the customer's social network.

18. The apparatus of claim 16, wherein the instruction code configured to cause an apparatus to determine the levels of connection between two or more of the connections of the customer comprises instruction code configured to cause an apparatus to:
analyze an image of the customer and at least one of the two or more connections of the customer;
analyze an image caption of the image of the customer and at least one of the two or more connections of the customer; and
confirm that at least one of the two or more connections of the customer is a contact in the customer's social network based on the analysis of the image and the image caption.

19. The method of claim 1, wherein the instruction code configured to cause an apparatus to monitor customer data that is indicative of a customer's personal circumstances comprises instruction code configured to cause an apparatus to:
receive customer data of the customer; and
identify customer data of the customer that is indicative of the customer's personal circumstances.

20. The method of claim 1, wherein the instruction code configured to cause an apparatus to share the indication with the one or more partnering service providers comprises instruction code configured to cause an apparatus to share the customer data that is indicative of a customer's personal circumstances with the one or more partnering service providers.
